(19) United States
(12) Patent Application Publication
(10) Pub. No.: US 2016/0210722 A1
(43) Pub. Date: Jul. 21, 2016

(54) RENDERING APPARATUS, RENDERING METHOD THEREOF, PROGRAM AND RECORDING MEDIUM

(71) Applicant: SQUARE ENIX HOLDINGS CO., LTD., Tokyo (JP)

(72) Inventor: Jean-François F FORTIN, Montreal (CA)

(73) Assignee: SQUARE ENIX HOLDINGS CO., LTD., Tokyo (JP)

(21) Appl. No.: 14/914,053

(22) PCT Filed: Aug. 15, 2014
(86) PCT No.: PCT/JP2014/071942

§ 371 Date: Feb. 24, 2016

Related U.S. Application Data
(60) Provisional application No. 61/876,318, filed on Sep. 11, 2013.

(51) Int. Cl. G06T 1/20; G06F 3/14; G06T 11/00; A63F 13/355; A63F 13/52

(52) U.S. Cl. CPC G06T 1/20; A63F 13/355; A63F 13/52; G06T 11/001; G06F 3/1423

(57) ABSTRACT

A rendering apparatus renders a plurality of screens, where at least a portion of rendering objects included in the plurality of screens are common to the plurality of screens. The apparatus identifies, from the common rendering objects, a first rendering object of which rendering attributes are static and a second rendering object of which rendering attributes are variable. The apparatus collectively performs rendering processing for the first rendering object for the plurality of screens and separately performs rendering processing for the second rendering object for each of the plurality of screens.

This application claims the benefit of U.S. Provisional Patent Application No. 61/876,318, filed Sep. 11, 2013, which is hereby incorporated by reference herein in its entirety.

### TECHNICAL FIELD

The present invention relates generally to image processing and, more particularly, to a method and apparatus for customizing an image visible to multiple users.

### BACKGROUND ART

The video game industry has seen considerable evolution, from the introduction of stand-alone arcade games, to home-based computer games, to the emergence of games made for specialized consoles. Widespread public access to the Internet then led to another major development, namely “cloud gaming”. In a cloud gaming system, a player can utilize an ordinary Internet-enabled appliance such as a smartphone or tablet to connect to a video game server over the Internet. The video game server starts a session for the player, and may do so for multiple players. The video game server renders video data and generates audio for the player based on player actions (e.g., moves, selections) and other attributes of the game. Encoded video and audio is delivered to the player's device over the Internet, and is reproduced as visible images and audible sounds. In this way, players from anywhere in the world can play a video game without the use of specialized video game consoles, software or graphics processing hardware.

When generating graphics for a multi-player video game, it may be possible to share certain resources, such as rendering, processing or bandwidth resources, when the same image is to be duplicated for multiple players. Meanwhile, it is recognized that to make the gaming experience more lively and enjoyable, the graphical appearance of objects in a scene may need to be customized for different players, even if they share the same scene. Since the requirements of resource sharing and customization run counter to one another, a solution that achieves both would be welcome in the industry.

### SUMMARY OF INVENTION

The present invention was made in view of such problems in the conventional technique.

The present invention in its first aspect provides a rendering apparatus for rendering a plurality of screens, where at least a portion of rendering objects included in the plurality of screens are common to the plurality of screens, comprising: identifying means for identifying, from the common rendering objects, a first rendering object of which rendering attributes are static and a second rendering object of which rendering attributes are variable; first rendering means for collectively performing rendering processing for the first rendering object for the plurality of screens; and second rendering means for separately performing rendering processing for the second rendering object for each of the plurality of screens.

The present invention in its second aspect provides a rendering method for rendering a plurality of screens, where at least a portion of rendering objects included in the plurality of screens are common to the plurality of screens, comprising: identifying, from the common rendering objects, a first rendering object of which rendering attributes are static and a second rendering object of which rendering attributes are variable; collectively performing rendering processing for the first rendering object for the plurality of screens; and separately performing rendering processing for the second rendering object for each of the plurality of screens.

Further features of the present invention will become apparent from the following description of exemplary embodiments (with reference to the attached drawings).

### BRIEF DESCRIPTION OF DRAWINGS

FIG. 1A is a block diagram of a cloud-based video game system architecture including a server system, according to a non-limiting embodiment of the present invention.

FIG. 1B is a block diagram of the cloud-based video game system architecture of FIG. 1A, showing interaction with the set of client devices over the data network during game play, according to a non-limiting embodiment of the present invention.

FIG. 2A is a block diagram showing various physical components of the architecture of FIG. 1, according to a non-limiting embodiment of the present invention.

FIG. 2B is a variant of FIG. 2A.

FIG. 2C is a block diagram showing various functional modules of the server system in the architecture of FIG. 1, which can be implemented by the physical components of FIG. 2A or 2B and which may be operational during game play.

FIGS. 3A to 3C are flowcharts showing execution of a set of processes carried out during execution of a video game, in accordance with non-limiting embodiments of the present invention.

FIGS. 4A and 4B are flowcharts showing operation of a client device to process received video and audio, respectively, in accordance with non-limiting embodiments of the present invention.

FIG. 5 depicts objects within the screen rendering range of multiple users, including a generic object and a customizable object, in accordance with a non-limiting embodiment of the present invention.

FIG. 6A conceptually illustrates an object database in accordance with a non-limiting embodiment of the present invention.

FIG. 6B conceptually illustrates a texture database in accordance with a non-limiting embodiment of the present invention.

FIG. 7 conceptually illustrates a graphics pipeline.

FIG. 8 is a flowchart illustrating steps in a pixel processing sub-process of the graphics pipeline, in accordance with a non-limiting embodiment of the present invention.

FIG. 9 is a flowchart illustrating further detail of the pixel processing sub-process in the case where the object being rendered is a generic object, in accordance with a non-limiting embodiment of the present invention.

FIGS. 10A and 10B are flowcharts illustrating further detail of a first pass and a second pass, respectively, of the pixel processing sub-process in the case where the object being rendered is a customizable object, in accordance with a non-limiting embodiment of the present invention.

FIG. 11 depicts objects within the frame buffer of multiple users, in accordance with a non-limiting embodiment of the present invention.

FIG. 12 conceptually shows evolution over time of a frame buffer for two participants, in accordance with a non-limiting embodiment of the present invention.

### DESCRIPTION OF EMBODIMENTS

I. Cloud Gaming Architecture

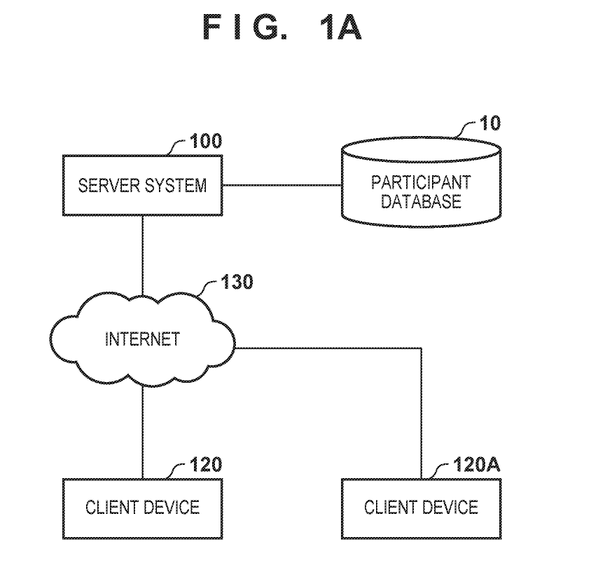

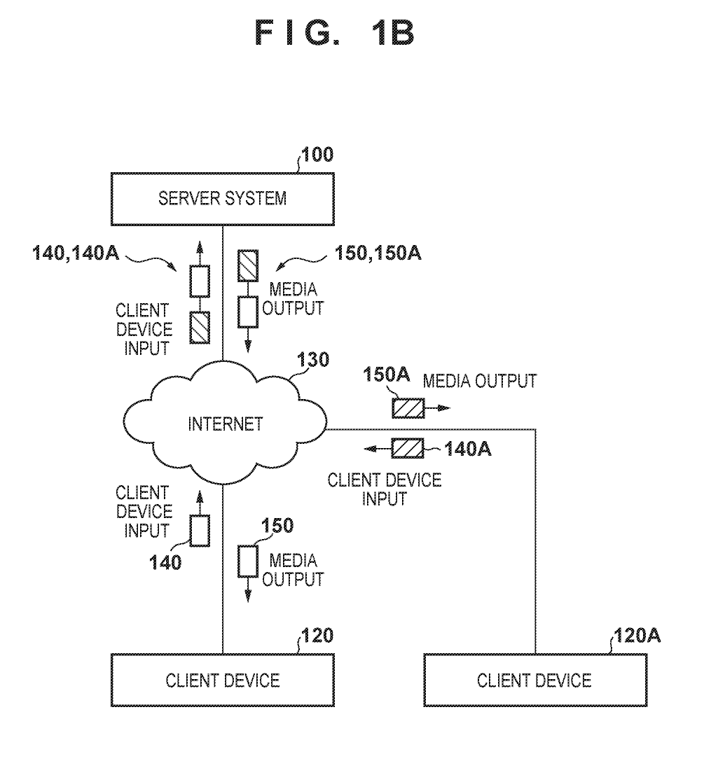

FIG. 1A schematically shows a cloud-based video game system architecture according to a non-limiting embodiment of the present invention. The architecture may include client devices 120, 120A connected to a server system 100 over a data network such as the Internet 130. Although only two client devices 120, 120A are shown, it should be appreciated that the number of client devices in the cloud-based video game system architecture is not particularly limited.

The configuration of the client devices 120, 120A is not particularly limited. In some embodiments, one or more of the client devices 120, 120A may be, for example, a personal computer (PC), a home game machine (console such as XBOX™, PS3™, Wii™, etc.), a portable game machine, a smart television, a set-top box (STB), etc. In other embodiments, one or more of the client devices 120, 120A may be a communication or computing device such as a mobile phone, a personal digital assistant (PDA), or a tablet.

Each of the client devices 120, 120A may connect to the Internet 130 in any suitable manner, including over a respective local access network (not shown). The server system 100 may also connect to the Internet 130 over a local access network (not shown), although the server system 100 may connect directly to the Internet 130 without the intermediary of a local access network. Connections between the cloud gaming server system 100 and one or more of the client devices 120, 120A may comprise one or more channels. These channels can be made up of physical and/or logical links, and may travel over a variety of physical media, including radio frequency, fiber optic, free-space optical, coaxial and twisted pair. The channels may abide by a protocol such as UDP or TCP/IP. Also, one or more of the channels may be supported a virtual private network (VPN). In some embodiments, one or more of the connections may be session-based.

The server system 100 may enable users of the client devices 120, 120A to play video games, either individually (i.e., a single-player video game) or in groups (i.e., a multi-player video game). The server system 100 may also enable users of the client devices 120, 120A to spectate games being played by other players. Non-limiting examples of video games may include games that are played for leisure, education and/or sport. A video game may but need not offer participants the possibility of monetary gain.

The server system 100 may also enable users of the client devices 120, 120A to test video games and/or administer the server system 100.

The server system 100 may include one or more computing resources, possibly including one or more game servers, and may comprise or have access to one or more databases, possibly including a participant database 10. The participant database 10 may store account information about various participants and client devices 120, 120A, such as identification data, financial data, location data, demographic data, connection data and the like. The game server(s) may be embodied in common hardware or they may be different servers that are connected via a communication link, including possibly over the Internet 130. Similarly, the database(s) may be embodied within the server system 100 or they may be connected thereto via a communication link, possibly over the Internet 130.

The server system 100 may implement an administrative application for handling interaction with client devices 120, 120A outside the game environment, such as prior to game play. For example, the administrative application may be configured for registering a user of one of the client devices 120, 120A in a user class (such as a “player”, “spectator”, “administrator” or “tester”), tracking the user's connectivity over the Internet, and responding to the user's command(s) to launch, join, exit or terminate an instance of a game, among several non-limiting functions. To this end, the administrative application may need to access the participant database 10.

The administrative application may interact differently with users in different user classes, which may include “player”, “spectator”, “administrator” and “tester”, to name a few non-limiting possibilities. Thus, for example, the administrative application may interface with a player (i.e., a user in the “player” user class) to allow the player to set up an account in the participant database 10 and select a video game to play. Pursuant to this selection, the administrative application may invoke a server-side video game application. The server-side video game application may be defined by computer-readable instructions that execute a set of functional modules for the player, allowing the player to control a character, avatar, race car, cockpit, etc. within a virtual world of a video game. In the case of a multi-player video game, the virtual world may be shared by two or more players, and one player's game play may affect that of another. In another example, the administrative application may interface with a spectator (i.e., a user in the “spectator” user class) to allow the spectator to set up an account in the participant database 10 and select a video game from a list of ongoing video games that the user may wish to spectate. Pursuant to this selection, the administrative application may invoke a set of functional modules for that spectator, allowing the spectator to observe game play of other users but not to control active characters in the game. (Unless otherwise indicated, where the term “participant” is used, it is meant to apply equally to both the “player” user class and the “spectator” user class.)

In a further example, the administrative application may interface with an administrator (i.e., a user in the “administrator” user class) to allow the administrator to change various features of the game server application, perform updates and manage player/spectator accounts.

In yet another example, the game server application may interface with a tester (i.e., a user in the “tester” user class) to allow the tester to select a video game to test. Pursuant to this selection, the game server application may invoke a set of functional modules for the tester, allowing the tester to test the video game.

FIG. 1B illustrates interaction that may take place between client devices 120, 120A and the server system 100 during game play, for users in the “player” or “spectator” user class.

In some non-limiting embodiments, the server-side video game application may cooperate with a client-side video game application, which can be defined by a set of computer-readable instructions executing on a client device, such as client device 120, 120A. Use of a client-side video game application may provide a customized interface for the participant to play or spectate the game and access game features. In other non-limiting embodiments, the client device does not feature a client-side video game application that is directly executable by the client device. Rather, a web browser may be used as the interface from the client device's perspective. The web browser may itself instantiate a client-side video game application within its own software environment so as to optimize interaction with the server-side video game application.

It should be appreciated that a given one of the client devices 120, 120A may be equipped with one or more input devices (such as a touch screen, a keyboard, a game controller, a joystick, etc.) to allow users of the given client device to provide input and participate in a video game. In other embodiments, the user may produce body motion or may wave an external object; these movements are detected by a camera or other sensor (e.g., Kinect™), while software operating within the given client device attempts to correctly guess whether the user intended to provide input to the given client device and, if so, the nature of such input. The client-side video game application running (either independently or within a browser) on the given client device may translate the received user inputs and detected user movements into “client device input”, which may be sent to the cloud gaming server system 100 over the Internet 130.

In the illustrated embodiment of FIG. 1B, client device 120 may produce client device input 140, while client device 120A may produce client device input 140A. The server system 100 may process the client device input 140, 140A received from the various client devices 120, 120A and may generate respective “media output” 150, 150A for the various client devices 120, 120A. The media output 150, 150A may include a stream of encoded video data (representing images when displayed on a screen) and audio data (representing sound when played via a loudspeaker). The media output 150, 150A may be sent over the Internet 130 in the form of packets. Packets destined for a particular one of the client devices 120, 120A may be addressed in such a way as to be routed to that device over the Internet 130. Each of the client devices 120, 120A may include circuitry for buffering and processing the media output in the packets received from the cloud gaming server system 100, as well as a display for displaying images and a transducer (e.g., a loudspeaker) for outputting audio. Additional output devices may also be provided, such as an electro-mechanical system to induce motion.

It should be appreciated that a stream of video data can be divided into “frames”. The term “frame” as used herein does not require the existence of a one-to-one correspondence between frames of video data and images represented by the video data. That is to say, while it is possible for a frame of video data to contain data representing a respective displayed image in its entirety, it is also possible for a frame of video data to contain data representing only part of an image, and for the image to in fact require two or more frames in order to be properly reconstructed and displayed. By the same token, a frame of video data may contain data representing more than one complete image, such that N images may be represented using M frames of video data, where M<N.

II. Cloud Gaming Server System 100 (Distributed Architecture)

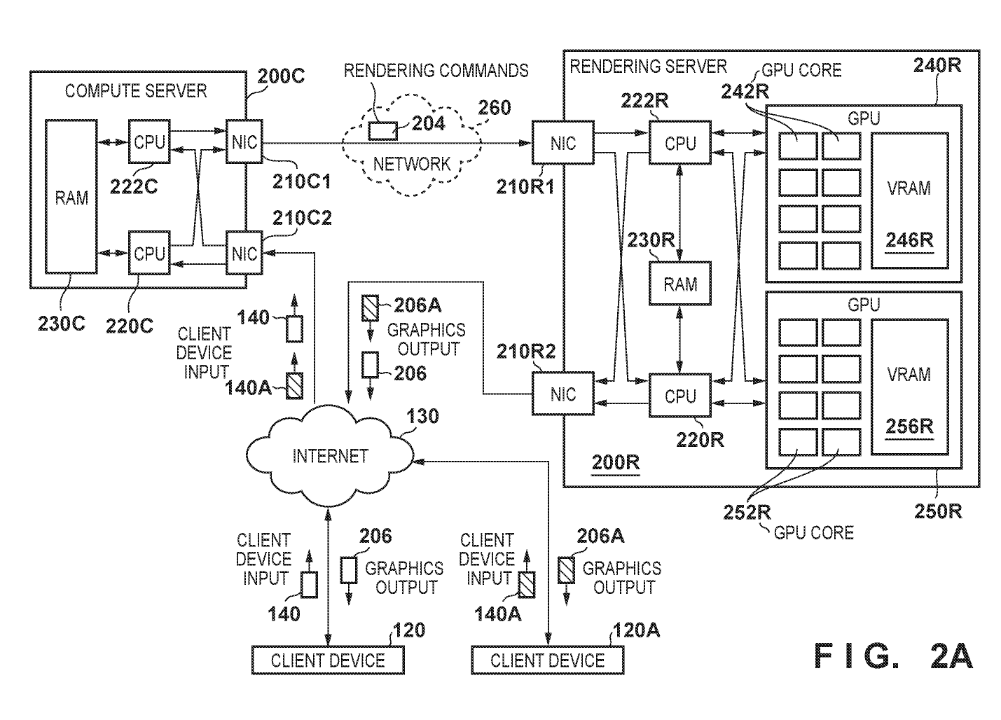

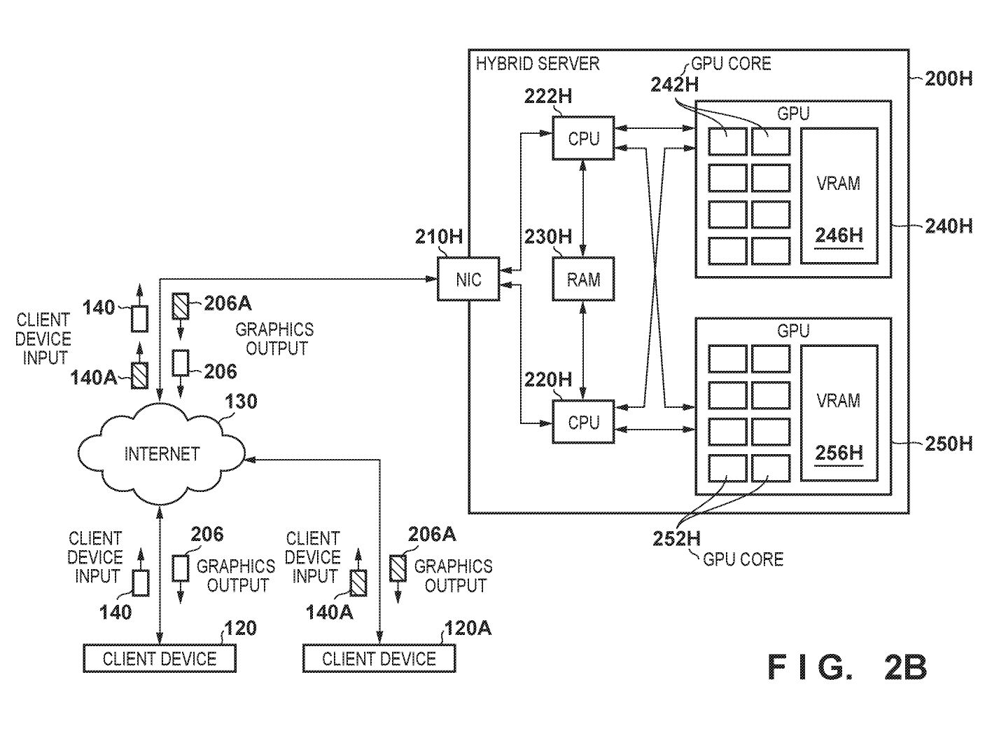

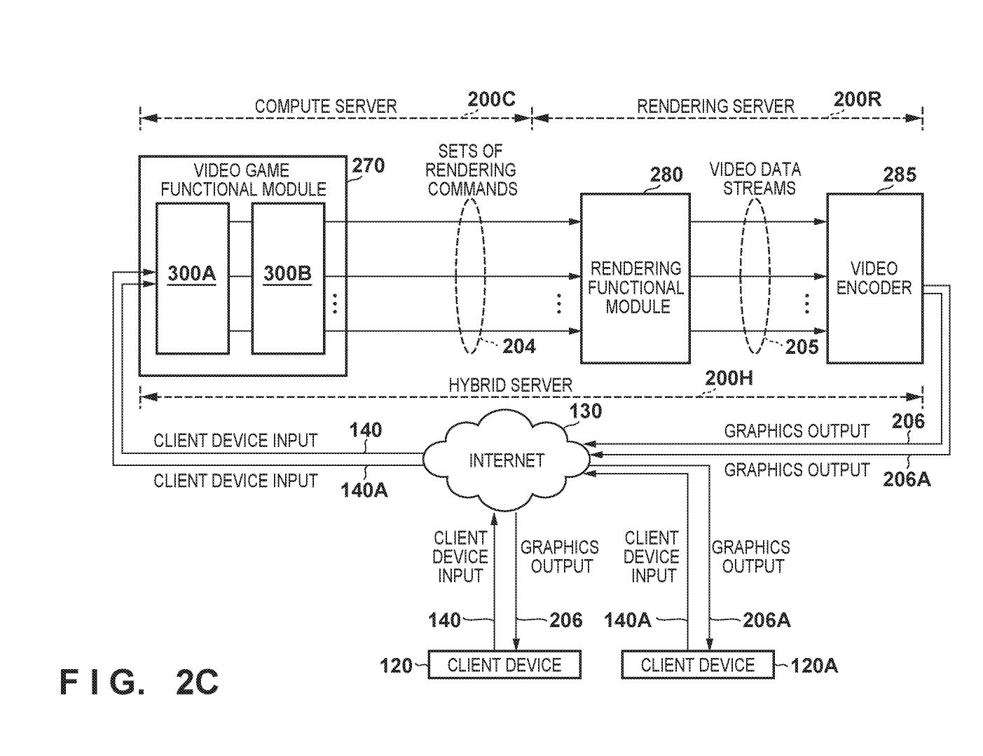

FIG. 2A shows one possible non-limiting physical arrangement of components for the cloud gaming server system 100. In this embodiment, individual servers within the cloud gaming server system 100 may be configured to carry out specialized functions. For example, a compute server 200C may be primarily responsible for tracking state changes in a video game based on user input, while a rendering server 200R may be primarily responsible for rendering graphics (video data).

For the purposes of the presently described example embodiment, both client device 120 and client device 120A are assumed to be participating in the video game, either as players or spectators. However, it should be understood that in some cases there may be a single player and no spectator, while in other cases there may be multiple players and a single spectator, in still other cases there may be a single player and multiple spectators and in yet other cases there may be multiple players and multiple spectators.

For the sake of simplicity, the following description refers to a single compute server 200C connected to a single rendering server 200R. However, it should be appreciated that there may be more than one rendering server 200R connected to the same compute server 200C, or more than one compute server 200C connected to the same rendering server 200R. In the case where there are multiple rendering servers 200R, these may be distributed over any suitable geographic area.

As shown in the non-limiting physical arrangement of components in FIG. 2A, the compute server 200C may comprise one or more central processing units (CPUs) 220C, 222C and a random access memory (RAM) 230C. The CPUs 220C, 222C can have access to the RAM 230C over a communication bus architecture, for example. While only two CPUs 220C, 222C are shown, it should be appreciated that a greater number of CPUs, or only a single CPU, may be provided in some example implementations of the compute server 200C. The compute server 200C may also comprise a network interface component (NIC) 210C2, where client device input is received over the Internet 130 from each of the client devices participating in the video game. In the presently described example embodiment, both client device 120 and client device 120A are assumed to be participating in the video game, and therefore the received client device input may include client device input 140 and client device input 140A.

The compute server 200C may further comprise another network interface component (NIC) 210C1, which outputs a sets of rendering commands 204. The sets of rendering commands 204 output from the compute server 200C via the NIC 210C1 may be sent to the rendering server 200R. In one embodiment, the compute server 200C may be connected directly to the rendering server 200R. In another embodiment, the compute server 200C may be connected to the rendering server 200R over a network 260, which may be the Internet 130 or another network. A virtual private network (VPN) may be established between the compute server 200C and the rendering server 200R over the network 260.

At the rendering server 200R, the sets of rendering commands 204 sent by the compute server 200C may be received at a network interface component (NIC) 210R1 and may be directed to one or more CPUs 220R, 222R. The CPUs 220R, 222R may be connected to graphics processing units (GPUs) 240R, 250R. By way of non-limiting example, GPU 240R may include a set of GPU cores 242R and a video random access memory (VRAM) 246R. Similarly, GPU 250R may include a set of GPU cores 252R and a video random access memory (VRAM) 256R. Each of the CPUs 220R, 222R may be connected to each of the GPUs 240R, 250R or to a subset of the GPUs 240R, 250R. Communication between the CPUs 220R, 222R and the GPUs 240R, 250R can be established using, for example, a communications bus architecture. Although only two CPUs and two GPUs are shown, there may be more than two CPUs and GPUs, or even just a single CPU or GPU, in a specific example of implementation of the rendering server 200R.

The CPUs 220R, 222R may cooperate with the GPUs 240R, 250R to convert the sets of rendering commands 204 into a graphics output streams, one for each of the participating client devices. In the present embodiment, there may be two graphics output streams 206, 206A for the client devices 120, 120A, respectively. This will be described in further detail later on. The rendering server 200R may comprise a further network interface component (NIC) 210R2, through which the graphics output streams 206, 206A may be sent to the client devices 120, 120A, respectively.

III. Cloud Gaming Server System 100 (Hybrid Architecture)

FIG. 2B shows a second possible non-limiting physical arrangement of components for the cloud gaming server system 100. In this embodiment, a hybrid server 200H may be responsible both for tracking state changes in a video game based on user input, and for rendering graphics (video data).

As shown in the non-limiting physical arrangement of components in FIG. 2B, the hybrid server 200H may comprise one or more central processing units (CPUs) 220H, 222H and a random access memory (RAM) 230H. The CPUs 220H, 222H may have access to the RAM 230H over a communication bus architecture, for example. While only two CPUs 220H, 222H are shown, it should be appreciated that a greater number of CPUs, or only a single CPU, may be provided in some example implementations of the hybrid server 200H. The hybrid server 200H may also comprise a network interface component (NIC) 210H, where client device input is received over the Internet 130 from each of the client devices participating in the video game. In the presently described example embodiment, both client device 120 and client device 120A are assumed to be participating in the video game, and therefore the received client device input may include client device input 140 and client device input 140A.

In addition, the CPUs 220H, 222H may be connected to a graphics processing units (GPUs) 240H, 250H. By way of non-limiting example, GPU 240H may include a set of GPU cores 242H and a video random access memory (VRAM) 246H. Similarly, GPU 250H may include a set of GPU cores 252H and a video random access memory (VRAM) 256H. Each of the CPUs 220H, 222H may be connected to each of the GPUs 240H, 250H or to a subset of the GPUs 240H, 250H. Communication between the CPUs 220H, 222H and the GPUs 240H, 250H may be established using, for example, a communications bus architecture. Although only two CPUs and two GPUs are shown, there may be more than two CPUs and GPUs, or even just a single CPU or GPU, in a specific example of implementation of the hybrid server 200H.

The CPUs 220H, 222H may cooperate with the GPUs 240H, 250H to convert the sets of rendering commands 204 into graphics output streams, one for each of the participating client devices. In this embodiment, there may be two graphics output streams 206, 206A for the participating client devices 120, 120A, respectively. The graphics output streams 206, 206A may be sent to the client devices 120, 120A, respectively, via the NIC 210H.

IV. Cloud Gaming Server System 100 (Functionality Overview)

During game play, the server system 100 runs a server-side video game application, which can be composed of a set of functional modules. With reference to FIG. 2C, these functional modules may include a video game functional module 270, a rendering functional module 280 and a video encoder 285. These functional modules may be implemented by the above-described physical components of the compute server 200C and the rendering server 200R (in FIG. 2A) and/or of the hybrid server 200H (in FIG. 2B). For example, according to the non-limiting embodiment of FIG. 2A, the video game functional module 270 may be implemented by the compute server 200C, while the rendering functional module 280 and the video encoder 285 may be implemented by the rendering server 200R. According to the non-limiting embodiment of FIG. 2B, the hybrid server 200H may implement the video game functional module 270, the rendering functional module 280 and the video encoder 285.

The present example embodiment discusses a single video game functional module 270 for simplicity of illustration. However, it should be noted that in an actual implementation of the cloud gaming server system 100, many video game functional modules similar to the video game functional module 270 may be executed in parallel. Thus, the cloud gaming server system 100 may support multiple independent instantiations of the same video game, or multiple different video games, simultaneously. Also, it should be noted that the video games can be single-player video games or multi-player games of any type.

The video game functional module 270 may be implemented by certain physical components of the compute server 200C (in FIG. 2A) or of the hybrid server 200H (in FIG. 2B). Specifically, the video game functional module 270 may be encoded as computer-readable instructions that are executable by a CPU (such as the CPUs 220C, 222C in the compute server 200C or the CPUs 220H, 222H in the hybrid server 200H). The instructions can be tangibly stored in the RAM 230C (in the compute server 200C) of the RAM 230H (in the hybrid server 200H) or in another memory area, together with constants, variables and/or other data used by the video game functional module 270. In some embodiments, the video game functional module 270 may be executed within the environment of a virtual machine that may be supported by an operating system that is also being executed by a CPU (such as the CPUs 220C, 222C in the compute server 200C or the CPUs 220H, 222H in the hybrid server 200H).

The rendering functional module 280 may be implemented by certain physical components of the rendering server 200R (in FIG. 2A) or of the hybrid server 200H (in FIG. 2B). In an embodiment, the rendering functional module 280 may take up one or more GPUs (240R, 250R in FIG. 2A, 240H, 250H in FIG. 2B) and may or may not utilize CPU resources.

The video encoder 285 may be implemented by certain physical components of the rendering server 200R (in FIG. 2A) or of the hybrid server 200H (in FIG. 2B). Those skilled in the art will appreciate that there are various ways in which to implement the video encoder 285. In the embodiment of FIG. 2A, the video encoder 285 may be implemented by the CPUs 220R, 222R and/or by the GPUs 240R, 250R. In the embodiment of FIG. 2B, the video encoder 285 may be implemented by the CPUs 220H, 222H and/or by the GPUs 240H, 250H. In yet another embodiment, the video encoder 285 may be implemented by a separate encoder chip (not shown).

In operation, the video game functional module 270 may produce the sets of rendering commands 204, based on received client device input. The received client device input may carry data (e.g., an address) identifying the video game functional module for which it is destined, as well as data identifying the user and/or client device from which it originates. Since the users of the client devices 120, 120A are participants in the video game (i.e., players or spectators), the received client device input may include the client device input 140, 140A received from the client devices 120, 120A.

Rendering commands refer to commands which may be used to instruct a specialized graphics processing unit (GPU) to produce a frame of video data or a sequence of frames of video data. Referring to FIG. 2C, the sets of rendering commands 204 result in the production of frames of video data by the rendering functional module 280. The images represented by these frames may change as a function of responses to the client device input 140, 140A that are programmed into the video game functional module 270. For example, the video game functional module 270 may be programmed in such a way as to respond to certain specific stimuli to provide the user with an experience of progression (with future interaction being made different, more challenging or more exciting), while the response to certain other specific stimuli will provide the user with an experience of regression or termination. Although the instructions for the video game functional module 270 may be fixed in the form of a binary executable file, the client device input 140, 140A is unknown until the moment of interaction with a player who uses the corresponding client device 120, 120A. As a result, there can be a wide variety of possible outcomes, depending on the specific client device input that is provided. This interaction between players/spectators and the video game functional module 270 via the client devices 120, 120A can be referred to as “game play” or “playing a video game”.

The rendering functional module 280 may process the sets of rendering commands 204 to create multiple video data streams 205. Generally, there may be one video data stream per participant (or, equivalently, per client device). When performing rendering, data for one or more objects represented in three-dimensional space (e.g., physical objects) or two-dimensional space (e.g., text) may be loaded into a cache memory (not shown) of a particular GPU 240R, 250R, 240H, 250H. This data may be transformed by the GPU 240R, 250R, 240H, 250H into data representative of a two-dimensional image, which may be stored in the appropriate VRAM 246R, 256R, 246H, 256H. As such, the VRAM 246R, 256R, 246H, 256H may provide temporary storage of picture element (pixel) values for a game screen.

The video encoder 285 may compress and encodes the video data in each of the video data streams 205 into a corresponding stream of compressed/encoded video data. The resultant streams of compressed/encoded video data, referred to as graphics output streams, may be produced on a per-client-device basis. In the present example embodiment, the video encoder 285 may produce graphics output stream 206 for client device 120 and graphics output stream 206A for client device 120A. Additional functional modules may be provided for formatting the video data into packets so that they can be transmitted over the Internet 130. The video data in the video data streams 205 and the compressed/encoded video data within a given graphics output stream may be divided into frames.

V. Generation of Rendering Commands

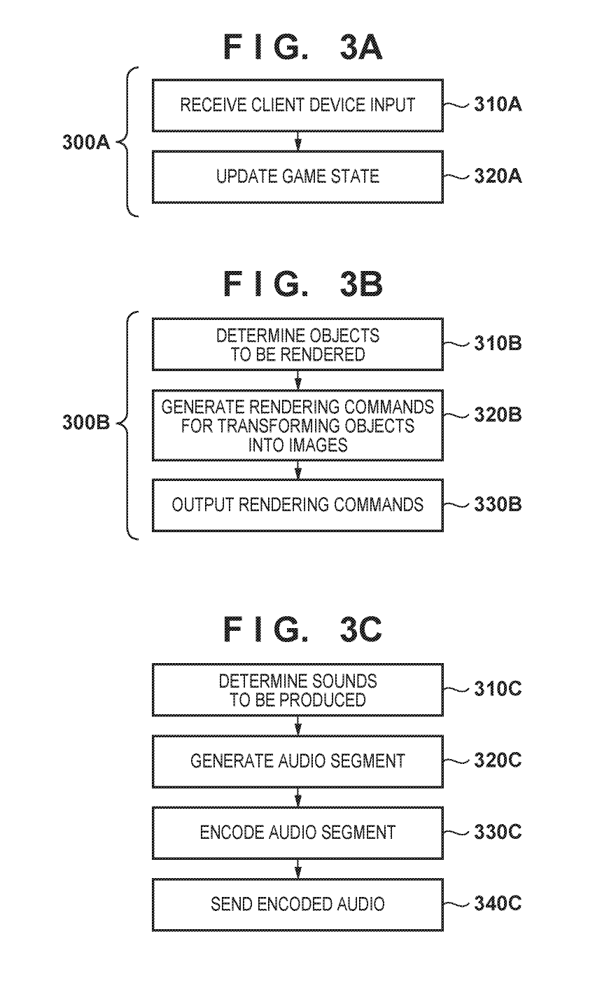

Generation of rendering commands by the video game functional module 270 is now described in greater detail with reference to FIGS. 2C, 3A and 3B. Specifically, execution of the video game functional module 270 may involve several processes, including a main game process 300A and a graphics control process 300B, which are described herein below in greater detail.

Main Game Process

The main game process 300A is described with reference to FIG. 3A. The main game process 300A may execute repeatedly as a continuous loop. As part of the main game process 300A, there may be provided an action 310A, during which client device input may be received. If the video game is a single-player video game without the possibility of spectating, then client device input (e.g., client device input 140) from a single client device (e.g., client device 120) is received as part of action 310A. If the video game is a multi-player video game or is a single-player video game with the possibility of spectating, then the client device input (e.g., the client device input 140 and 140A) from one or more client devices (e.g., the client devices 120 and 120A) may be received as part of action 310A.

By way of non-limiting example, the input from a given client device may convey that the user of the given client device wishes to cause a character under his or her control to move, jump, kick, turn, swing, pull, grab, etc. Alternatively or in addition, the input from the given client device may convey a menu selection made by the user of the given client device in order to change one or more audio, video or gameplay settings, to load/save a game or to create or join a network session. Alternatively or in addition, the input from the given client device may convey that the user of the given client device wishes to select a particular camera view (e.g., first-person or third-person) or reposition his or her viewpoint within the virtual world.

At action 320A, the game state may be updated based at least in part on the client device input received at action 310A and other parameters. Updating the game state may involve the following actions:

Firstly, updating the game state may involve updating certain properties of the participants (player or spectator) associated with the client devices from which the client device input may have been received. These properties may be stored in the participant database 10. Examples of participant properties that may be maintained in the participant database 10 and updated at action 320A can include a camera view selection (e.g., 1^{st} person, 3^{rd} person), a mode of play, a selected audio or video setting, a skill level, a customer grade (e.g., guest, premium, etc.).

Secondly, updating the game state may involve updating the attributes of certain objects in the virtual world based on an interpretation of the client device input. The objects whose attributes are to be updated may in some cases be represented by two- or three-dimensional models and may include playing characters, non-playing characters and other objects. In the case of a playing character, attributes that can be updated may include the object's position, strength, weapons/armor, lifetime left, special powers, speed/direction (velocity), animation, visual effects, energy, ammunition, etc. In the case of other objects (such as background, vegetation, buildings, vehicles, score board, etc.), attributes that can be updated may include the object's position, velocity, animation, damage/health, visual effects, textual content, etc.

It should be appreciated that parameters other than client device input may influence the above properties (of participants) and attributes (of virtual world objects). For example, various timers (such as elapsed time, time since a particular event, virtual time of day, total number of players, a participant's geographic location, etc.) can have an effect on various aspects of the game state.

Once the game state has been updated further to execution of action 320A, the main game process 300A may return to action 310A, whereupon new client device input received since the last pass through the main game process is gathered and processed.

Graphics Control Process

A second process, referred to as the graphics control process, is now described with reference to FIG. 3B. Although shown as separate from the main game process 300A, the graphics control process 300B may execute as an extension of the main game process 300A. The graphics control process 300B may execute continually resulting in generation of the sets of rendering commands 204. In the case of a single-player video game without the possibility of spectating, there is only one player and therefore only one resulting set of rendering commands 204 to be generated. In the case of a multi-player video game, multiple distinct sets of rendering commands need to be generated for the multiple players, and therefore multiple sub-processes may execute in parallel, one for each player. In the case of a single-player game with the possibility of spectating, there may again be only a single set of rendering commands 204, but the resulting video data stream may be duplicated for the spectators by the rendering functional module 280. Of course, these are only examples of implementation and are not to be taken as limiting.

Consider operation of the graphics control process 300B for a given participant requiring one of the video data streams 205. At action 310B, the video game functional module 270 may determine the objects to be rendered for the given participant. This action may include identifying the following types of objects:

Firstly, this action may include identifying those objects from the virtual world that are in the “game screen rendering range” (also known as a “scene”) for the given participant. The game screen rendering range may include a portion of the virtual world that would be “visible” from the perspective of the given participant's camera. This may depend on the position and orientation of that camera relative to the objects in the virtual world. In a non-limiting example of implementation of action 310B, a frustum may be applied to the virtual world, and the objects within that frustum are retained or marked. The frustum has an apex which may be situated at the location of the given participant's camera and may have a directionality also defined by the directionality of that camera.

Secondly, this action can include identifying additional objects that do not appear in the virtual world, but which nevertheless may need to be rendered for the given participant. For example, these additional objects may include textual messages, graphical warnings and dashboard indicators, to name a few non-limiting possibilities.

At action 320B, the video game functional module 270 may generate a set of commands for rendering into graphics (video data) the objects that were identified at action 310B. Rendering may refer to the transformation of 3-D or 2-D coordinates of an object or group of objects into data representative of a displayable image, in accordance with the viewing perspective and prevailing lighting conditions. This may be achieved using any number of different algorithms and techniques, for example as described in “Computer Graphics and Geometric Modelling: Implementation & Algorithms”, Max K. Agoston, Springer-Verlag London Limited, 2005, hereby incorporated by reference herein. The rendering commands may have a format that in conformance with a 3D application programming interface (API) such as, without limitation, “Direct3D” from Microsoft Corporation, Redmond, Wash., and “OpenGL” managed by Khronos Group, Beaverton, Oreg.

At action 330B, the rendering commands generated at action 320B may be output to the rendering functional module 280. This may involve packetizing the generated rendering commands into a set of rendering commands 204 that is sent to the rendering functional module 280.

VI. Generation of Graphics Output

The rendering functional module 280 may interpret the sets of rendering commands 204 and produces multiple video data streams 205, one for each participating client device. Rendering may be achieved by the GPUs 240R, 250R, 240H, 250H under control of the CPUs 220R, 222R (in FIG. 2A) or 220H, 222H (in FIG. 2B). The rate at which frames of video data are produced for a participating client device may be referred to as the frame rate.

In an embodiment where there are N participants, there may be N sets of rendering commands 204 (one for each participant) and also N video data streams 205 (one for each participant). In that case, rendering functionality is not shared among the participants. However, the N video data streams 205 may also be created from M sets of rendering commands 204 (where M<N), such that fewer sets of rendering commands need to be processed by the rendering functional module 280. In that case, the rendering functional unit 280 may perform sharing or duplication in order to generate a larger number of video data streams 205 from a smaller number of sets of rendering commands 204. Such sharing or duplication may be prevalent when multiple participants (e.g., spectators) desire to view the same camera perspective. Thus, the rendering functional module 280 may perform functions such as duplicating a created video data stream for one or more spectators.

Next, the video data in each of the video data streams 205 may be encoded by the video encoder 285, resulting in a sequence of encoded video data associated with each client device, referred to as a graphics output stream. In the example embodiments of FIGS. 2A-2C, the sequence of encoded video data destined for client device 120 is referred to as graphics output stream 206, while the sequence of encoded video data destined for client device 120A is referred to as graphics output stream 206A.

The video encoder 285 may be a device (or set of computer-readable instructions) that enables or carries out or defines a video compression or decompression algorithm for digital video. Video compression may transform an original stream of digital image data (expressed in terms of pixel locations, color values, etc.) into an output stream of digital image data that conveys substantially the same information but using fewer bits. Any suitable compression algorithm may be used. In addition to data compression, the encoding process used to encode a particular frame of video data may or may not involve cryptographic encryption.

The graphics output streams 206, 206A created in the above manner may be sent over the Internet 130 to the respective client devices. By way of non-limiting example, the graphics output streams may be segmented and formatted into packets, each having a header and a payload. The header of a packet containing video data for a given participant may include a network address of the client device associated with the given participant, while the payload may include the video data, in whole or in part. In a non-limiting embodiment, the identity and/or version of the compression algorithm used to encode certain video data may be encoded in the content of one or more packets that convey that video data. Other methods of transmitting the encoded video data may occur to those of skill in the art.

While the present description focuses on the rendering of video data representative of individual 2-D images, the present invention does not exclude the possibility of rendering video data representative of multiple 2-D images per frame to create a 3-D effect.

VII. Game Screen Reproduction at Client Device

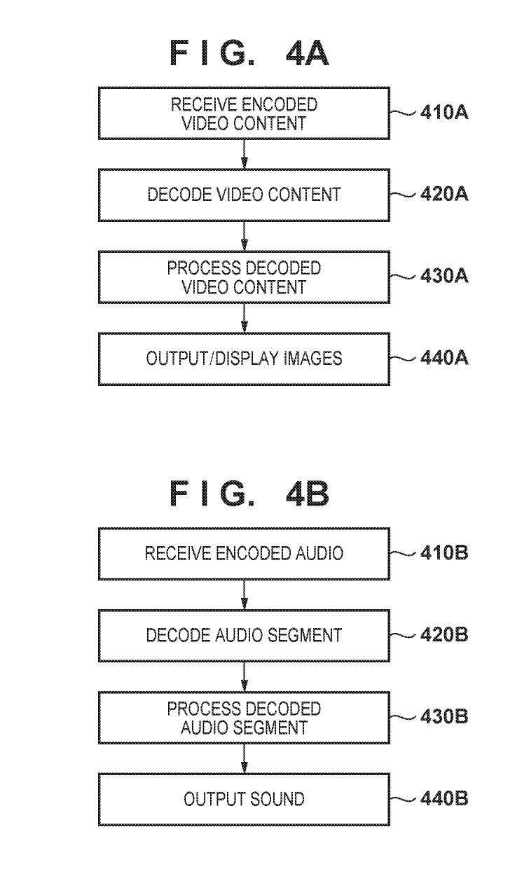

Reference is now made to FIG. 4A, which shows operation of a client-side video game application that may be executed by the client device associated with a given participant, which may be client device 120 or client device 120A, by way of non-limiting example. In operation, the client-side video game application may be executable directly by the client device or it may run within a web browser, to name a few non-limiting possibilities.

At action 410A, a graphics output stream (e.g., 206, 206A) may be received over the Internet 130 from the rendering server 200R (FIG. 2A) or from the hybrid server 200H (FIG. 2B), depending on the embodiment. The received graphics output stream may comprise compressed/encoded of video data which may be divided into frames.

At action 420A, the compressed/encoded frames of video data may be decoded/decompressed in accordance with the decompression algorithm that is complementary to the encoding/compression algorithm used in the encoding/compression process. In a non-limiting embodiment, the identity or version of the encoding/compression algorithm used to encode/compress the video data may be known in advance. In other embodiments, the identity or version of the encoding/compression algorithm used to encode the video data may accompany the video data itself.

At action 430A, the (decoded/decompressed) frames of video data may be processed. This can include placing the decoded/decompressed frames of video data in a buffer, performing error correction, reordering and/or combining the data in multiple successive frames, alpha blending, interpolating portions of missing data, and so on. The result may be video data representative of a final image to be presented to the user on a per-frame basis.

At action 440A, the final image may be output via the output mechanism of the client device. For example, a composite video frame may be displayed on the display of the client device.

VIII. Audio Generation

A third process, referred to as the audio generation process, is now described with reference to FIG. 3C. The audio generation process may execute continually for each participant requiring a distinct audio stream. In one embodiment, the audio generation process may execute independently of the graphics control process 300B. In another embodiment, execution of the audio generation process and the graphics control process may be coordinated.

At action 310C, the video game functional module 270 may determine the sounds to be produced. Specifically, this action may include identifying those sounds associated with objects in the virtual world that dominate the acoustic landscape, due to their volume (loudness) and/or proximity to the participant within the virtual world.

At action 320C, the video game functional module 270 may generate an audio segment. The duration of the audio segment may span the duration of a video frame, although in some embodiments, audio segments may be generated less frequently than video frames, while in other embodiments, audio segments may be generated more frequently than video frames.

At action 330C, the audio segment may be encoded, e.g., by an audio encoder, resulting in an encoded audio segment. The audio encoder can be a device (or set of instructions) that enables or carries out or defines an audio compression or decompression algorithm. Audio compression may transform an original stream of digital audio (expressed as a sound wave changing in amplitude and phase over time) into an output stream of digital audio data that conveys substantially the same information but using fewer bits. Any suitable compression algorithm may be used. In addition to audio compression, the encoding process used to encode a particular audio segment may or may not apply cryptographic encryption.

It should be appreciated that in some embodiments, the audio segments may be generated by specialized hardware (e.g., a sound card) in either the compute server 200C (FIG. 2A) or the hybrid server 200H (FIG. 2B). In an alternative embodiment that may be applicable to the distributed arrangement of FIG. 2A, the audio segment may be parameterized into speech parameters (e.g., LPC parameters) by the video game functional module 270, and the speech parameters can be redistributed to the destination client device (e.g., client device 120 or client device 120A) by the rendering server 200R.

The encoded audio created in the above manner is sent over the Internet 130. By way of non-limiting example, the encoded audio input may be broken down and formatted into packets, each having a header and a payload. The header may carry an address of a client device associated with the participant for whom the audio generation process is being executed, while the payload may include the encoded audio. In a non-limiting embodiment, the identity and/or version of the compression algorithm used to encode a given audio segment may be encoded in the content of one or more packets that convey the given segment. Other methods of transmitting the encoded audio may occur to those of skill in the art.

Reference is now made to FIG. 4B, which shows operation of the client device associated with a given participant, which may be client device 120 or client device 120A, by way of non-limiting example.

At action 410B, an encoded audio segment may be received from the compute server 200C, the rendering server 200R or the hybrid server 200H (depending on the embodiment). At action 420B, the encoded audio may be decoded in accordance with the decompression algorithm that is complementary to the compression algorithm used in the encoding process. In a non-limiting embodiment, the identity or version of the compression algorithm used to encode the audio segment may be specified in the content of one or more packets that convey the audio segment.

At action 430B, the (decoded) audio segments may be processed. This may include placing the decoded audio segments in a buffer, performing error correction, combining multiple successive waveforms, and so on. The result may be a final sound to be presented to the user on a per-frame basis.

At action 440B, the final generated sound may be output via the output mechanism of the client device. For example, the sound may be played through a sound card or loudspeaker of the client device.

IX. Specific Description of Non-Limiting Embodiments

A more detailed description of certain non-limiting embodiments of the present invention is now provided.

For the purposes of the present non-limiting description of certain non-limiting embodiments of the invention, let it be assumed that two or more participants (players or spectators) in a video game have the same position and camera perspective. That is to say, the same scene is being viewed by the two or more participants. For example, one participant may be a player and the other participants may be individual spectators. The scene is assumed to include various objects. In non-limiting embodiments of the present invention, some of these objects (so-called “generic” objects) are rendered once and shared, and therefore will have the same graphical representation for each of the participants. In addition, one or more of the objects in the scene (so-called “customizable” objects) will be rendered in a customized manner. Thus, although they occupy a common position in the scene for all participants, the customizable objects will have a graphical representation that varies from participant to participant. As a result, the images of the rendered scene will include a first portion, containing the generic objects, that is the same for all participants and a second portion, containing the customizable objects, that may vary among participants. In the following, the term “participant” may be used interchangeably with the term “user”.

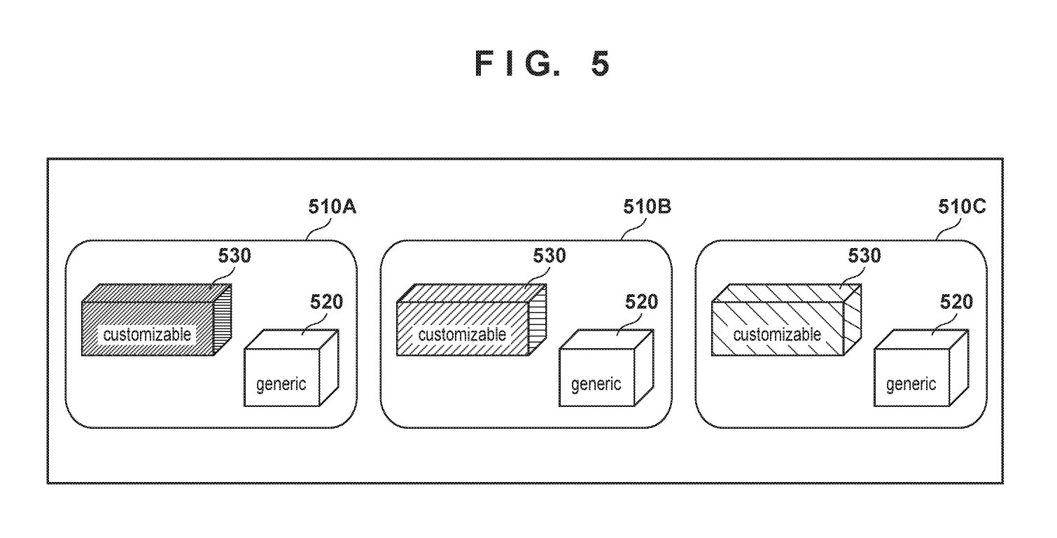

FIG. 5 conceptually illustrates a plurality of images 510A, 510B, 510C represented by the video/image data that may be produced for participants A, B, C. While in the present example there are three participants A, B and C, it is to be understood that in a given implementation, there may be any number of participants. The images 510A, 510B, 510C depict an object 520 that may be common to all participants. For ease of reference, object 520 will be referred to as a “generic” object. In addition, the images 510A, 510B, 510C depict an object 530 that may be customized for each participant. For ease of reference, object 530 will be referred to as a “customizable” object. A customizable object could be any object in a scene that could be customized so as to have a different texture for different participants, yet be subjected to lighting conditions that are common amongst those participants. As such, there is no particular limitation on the type of object that may be a generic object as opposed to a customizable object. In one example, a customizable object could be a scene object.

In the illustrated example, there is shown a single generic object 520 and a single customizable object 530. However, this is not to be considered limiting, as it is to be understood that in a given implementation, there may be any number of generic objects and any number of customizable objects. Moreover, the objects can have any size or shape.

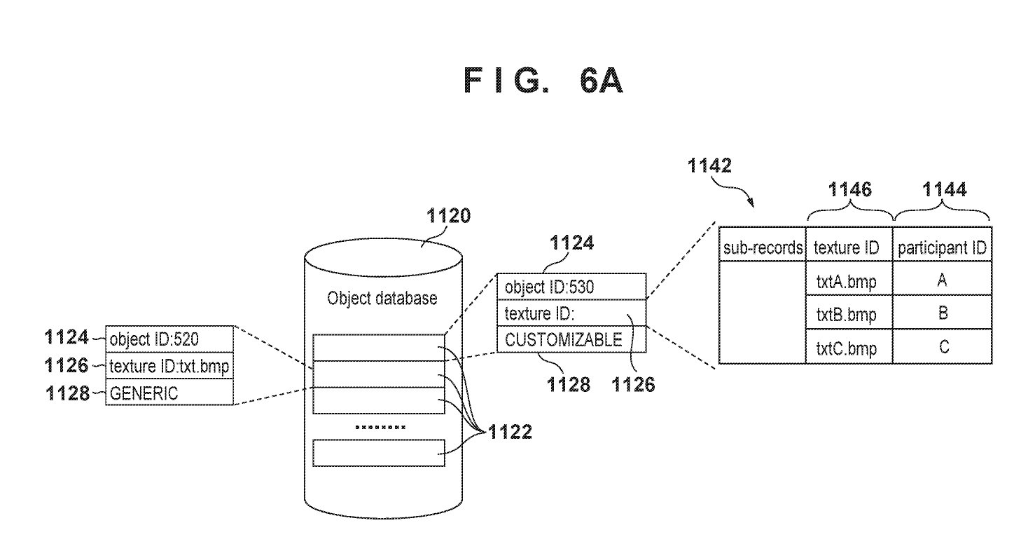

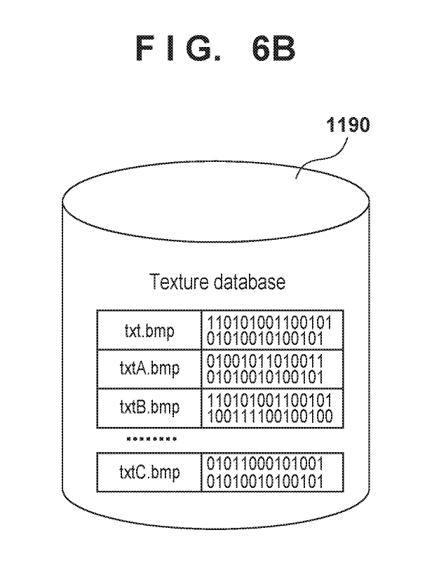

A particular object that is to be rendered may be classified as a generic object or a customizable object. The decision regarding whether an object is to be considered a generic object or a customizable object may be made by the main game process 300A, based on a variety of factors. Such factors may include the object's position or depth in the scene, or there may simply be certain objects that are pre-identified as being either generic or customizable. With reference to FIG. 6A, the identification of an object as generic or customizable may be stored in an object database 1120. The object database 1120 may be embodied at least in part using computer memory. The object database 1120 may be maintained by the main game process 300A and accessible to the graphics control process 300B and/or the rendering functional module 280, depending on the embodiment being implemented.

The object database 1120 may include a record 1122 for each object and a set of fields 1124, 1126, 1128 in each record 1122 for storing various information about the object. For example, among others, there may be an identifier field 1124 (storing an object ID) and a texture field 1126 (storing a texture ID which links to an image file in a texture database—not shown) and a customization field 1128 (storing an indication of whether the object is a generic object or a customizable object).

In the case where a given object is a generic object (such as for the object having object ID “520”, and where the contents of the customization field 1128 is shown as “generic”), the texture identified by the texture ID (in this case, “txt.bmp”) stored in the corresponding texture field 1126 is the one that will be used to represent the generic object in the final image viewed by all participants. The texture itself may constitute a file stored in a texture database 1190 (see FIG. 6B) and indexed by the texture ID (in this case, “txt.bmp”). The texture database 1190 may be embodied at least in part using computer memory.

In case a given object is a customizable object (such as for the object having object ID “530”, and where the contents of the customization field 1128 is shown as “customizable”), different participants may see different textures being applied to this object. Thus, with continued reference to FIG. 6A, the would-be texture field may be replaced with a set of sub-records 1142, one for each of two or more participants, where each sub-record includes a participant field 1144 (storing a participant ID) and a texture field 1146 (storing a texture ID which links to an image file in the texture database). The textures themselves may consist of files stored in the texture database 1190 (see FIG. 6B) and indexed by the texture ID (in this case, “txtA.bmp”, “txtB.bmp” and “txtC.bmp” are texture IDs respectively associated with participants A, B and C).

The use of a customization field 1128, sub-records 1142 and texture field 1146 is but one specific way to encode the information regarding the customizable object 530 in the object database 1120, and is not to be considered limiting.

Thus, a single customizable object may be associated with multiple textures associated with multiple respective participants. The association between textures and participants, for a given customizable object, may depend on a variety of factors. These factors may include information stored in the participant database 10 regarding the various participants, such as identification data, financial data, location data, demographic data, connection data and the like. Participants may even be given the opportunity to select the texture that they wish to have associated with the particular customizable object.

Example of Implementation

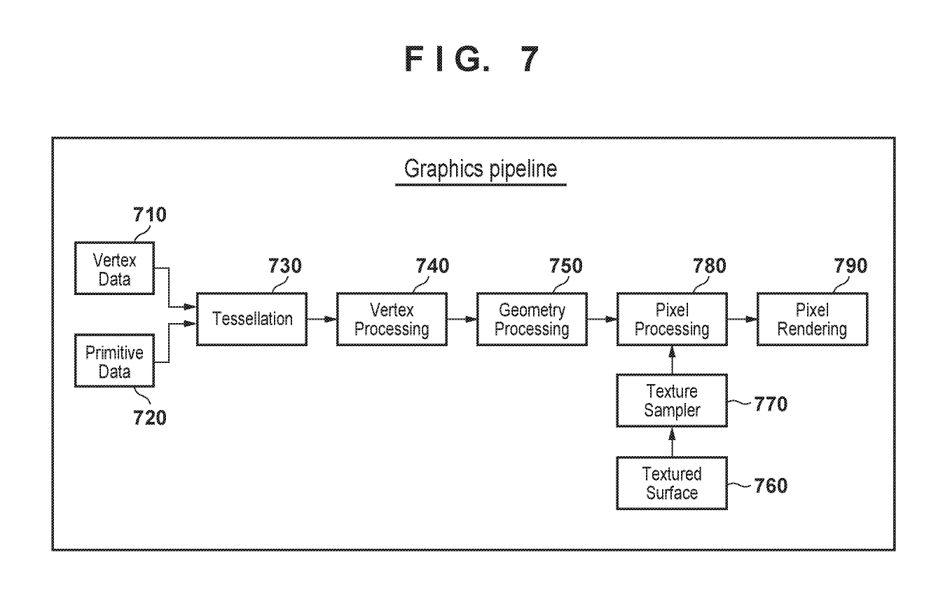

FIG. 7 illustrates an example graphics pipeline that may be implemented by the rendering functional module 280, based on rendering commands received from the video game functional module 270. It will be recalled that the video game functional module may reside on the same computing apparatus as the rendering functional module 280 (see FIG. 2B) or on a different computing apparatus (see FIG. 2A). It should be appreciated that execution of computations forming part of the graphics pipeline is defined by the rendering commands, that is to say, the rendering commands are issued by the video game functional module 270 in such a way as to cause the rendering functional unit 280 to execute graphics pipeline operations. To this end, the video game functional module 270 and the rendering functional module 280 may utilize a certain protocol for encoding, decoding and interpreting the rendering commands.

The rendering pipeline shown in FIG. 7 forms part of the Direct3D architecture of Microsoft Corporation, Redmond, Wash., which was used by way of non-limiting example. Other systems may implement variations in the graphics pipeline. The illustrated graphics pipeline includes a plurality of building blocks (or sub-processes), which are listed and briefly described herein below:
710 Vertex Data:

Untransformed model vertices are stored in vertex memory buffers.
720 Primitive Data:

Geometric primitives, including points, lines, triangles, and polygons, are referenced in the vertex data with index buffers.
730 Tessellation:

The tessellator unit converts higher-order primitives, displacement maps, and mesh patches to vertex locations and stores those locations in vertex buffers.
740 Vertex Processing:

Direct3D transformations are applied to vertices stored in the vertex buffer.
750 Geometry Proc.:

Clipping, back face culling, attribute evaluation, and rasterization are applied to the transformed vertices.
760 Textured Surface:

Texture coordinates for Direct3D surfaces are supplied to Direct3D through the IDirect3DTexture9 interface.
770 Texture Sampler:

Texture level-of-detail filtering is applied to input texture values.
780 Pixel Processing:

Pixel shader operations use geometry data to modify input vertex and texture data, yielding output pixel values.
790 Pixel Rendering:

Final rendering processes modify pixel values with alpha, depth, or stencil testing, or by applying alpha blending or fog. All resulting pixel values are presented to the output display.

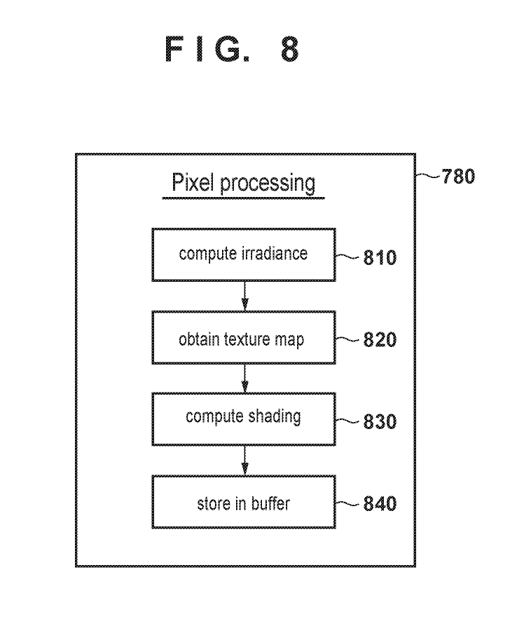

Turning now to FIG. 8, there is provided further detail regarding the pixel processing sub-process 780 in the graphics pipeline, adapted in accordance with non-limiting embodiments of the present invention. In particular, the pixel processing sub-process may include steps 810-840 performed for each pixel associated with an object, based on received rendering instructions. At step 810, irradiance may be computed, which can include the computation of lighting components including diffuse, specular, ambient, etc. At step 820, a texture for the object may be obtained. The texture may include diffuse color information. At step 830, per-pixel shading may be computed, where each pixel is attributed a pixel value, based on the diffuse color information and the lighting information. Finally, at step 840, the pixel value for each pixel is stored in a frame buffer.

In accordance with non-limiting embodiments of the present invention, execution of steps 810-840 of the pixel processing sub-process may depend on the type of object whose pixels are being processed, namely whether the object is a generic object or a customizable object. The difference between rendering pixels of a generic object viewed by multiple participants and rendering pixels of a customizable object viewed by multiple participants will now be described in greater detail. For the purposes of the present discussion, it is assumed that there are three participants A, B and C, although in actuality there may be any number of participants greater than or equal to two.

It will be appreciated that in order for the rendering functional unit 280 to know which set of processing steps to apply for a given set of pixels associated with a particular object, the rendering functional module 280 needs to know whether the particular object is a generic object or a customizable object. This can be learned by way of the rendering instructions received from the video game functional module 270. For example, the rendering commands may include an object ID. To determine whether the object is a generic object or a custom object, the rendering functional module 280 may consult the object database 1120 based on the object ID in order to find the appropriate record 1122, and then determine the contents of the customization field 1128 for that record 1122. In another embodiment, the rendering commands may themselves specify whether the particular object is a generic object or a customizable object, and may even include texture information or a link thereto.

(i) Pixel Processing for Generic Object 520

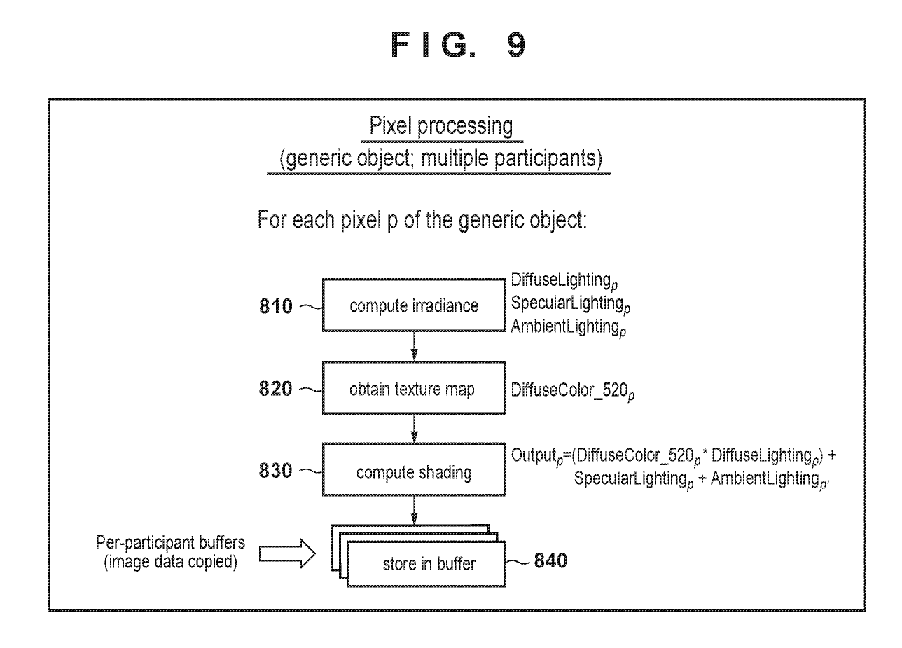

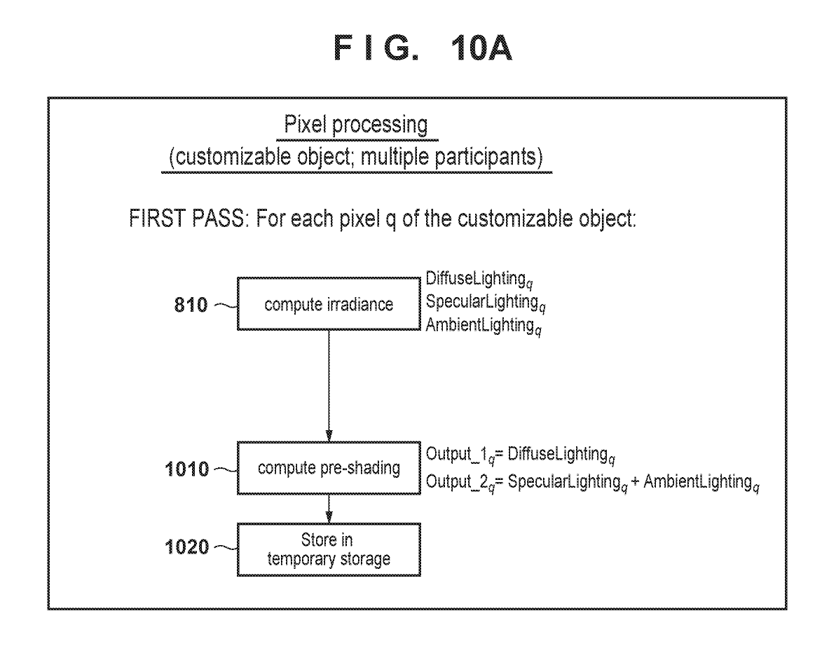

Reference is now made to FIG. 9, which illustrates steps 810-840 in the pixel processing sub-process 780 in the case of a generic object, such as object 520. These steps may be executed for each pixel p of the generic object and constitute a single pass through the pixel processing sub-process.

At step 810, the rendering functional module 280 may compute the spectral irradiance at pixel p, which could include a diffuse lighting component DiffuseLightingₚ, a specular lighting component SpecularLightingₚ and an ambient lighting component AmbientLightingₚ. The inputs to step 810 may include such items as the content of a depth buffer (also referred to as a “Z-buffer”), a normal buffer, a specular factor buffer, as well as the origin, direction, intensity, color and/or configuration of various light sources that have a bearing on the viewpoint being rendered, and a definition or parameterization of the lighting model used. As such, computing the irradiance may be a computationally intensive operation.

In a non-limiting embodiment, “DiffuseLightingₚ” is the sum (over i) of “DiffuseLighting(p,i)”, where “DiffuseLighting(p,i)” represents the intensity and color of diffuse lighting at pixel p from light source “i”. In a non-limiting embodiment, the value of DiffuseLighting(p,i), for a given light source “i”, can be computed as the dot product of the surface normal and the light source direction (also referenced as “n dot l”). Also, “SpecularLightingₚ” represents the intensity and color of specular lighting at pixel p. In a non-limiting embodiment, the value of SpecularLightingₚ may be calculated as the dot product of the reflected lighting vector and the view direction (also referenced as “r dot v”). Finally, “AmbientLightingₚ” represents the intensity and color of ambient lighting at pixel p. Also it should be appreciated that persons skilled in the art will be familiar with the precise mathematical algorithms used to compute DiffuseLightingₚ, SpecularLightingₚ and AmbientLightingₚ at pixel p.

At step 820, the rendering functional module 280 may consult the texture of the generic object (in this case, object 520) to obtain the appropriate color value at pixel p. The texture can be first identified by consulting the object database 1120 on the basis of the object ID to obtain the texture ID, and then the texture database 1190 can be consulted based on the obtained texture ID to obtain a diffuse color value at pixel p. The resulting diffuse color value is denoted DiffuseColor_520ₚ. Specifically, DiffuseColor_520ₚ may represent the sampled (or interpolated) value of the texture of object 520 at a point corresponding to pixel p.

At step 830, the rendering functional module 280 may compute the pixel value for pixel p. It should be noted that the term “pixel value” could refer to a scalar or to a multi-component vector. In a non-limiting embodiment, the components of such a multi-component vector may be the color (or hue, chroma), the saturation (intensity of the color itself) and the luminance. The word “intensity” may sometimes be used to represent the luminance component. In another non-limiting embodiment, the multiple components of a multi-component color vector may be RGB (red, green and blue). In one non-limiting embodiment, the pixel value, which for pixel p is denoted Outputₚ, can be computed by multiplicatively combining the diffuse color with the diffuse lighting component, and then adding thereto the specular lighting component and the ambient lighting component. That is to say, Outputₚ=(DiffuseColor_520ₚ*DiffuseLightingₚ)+SpecularLightingₚ+AmbientLightingₚ. It should be appreciated that Outputₚ may be computed separately for each of multiple components of pixel p (e.g., RGB, YCbCr, etc.).

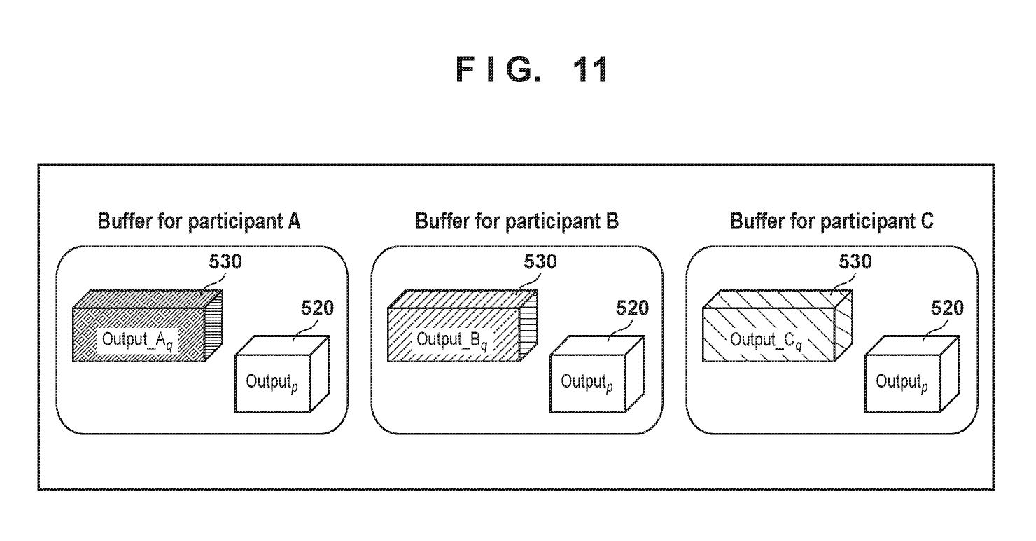

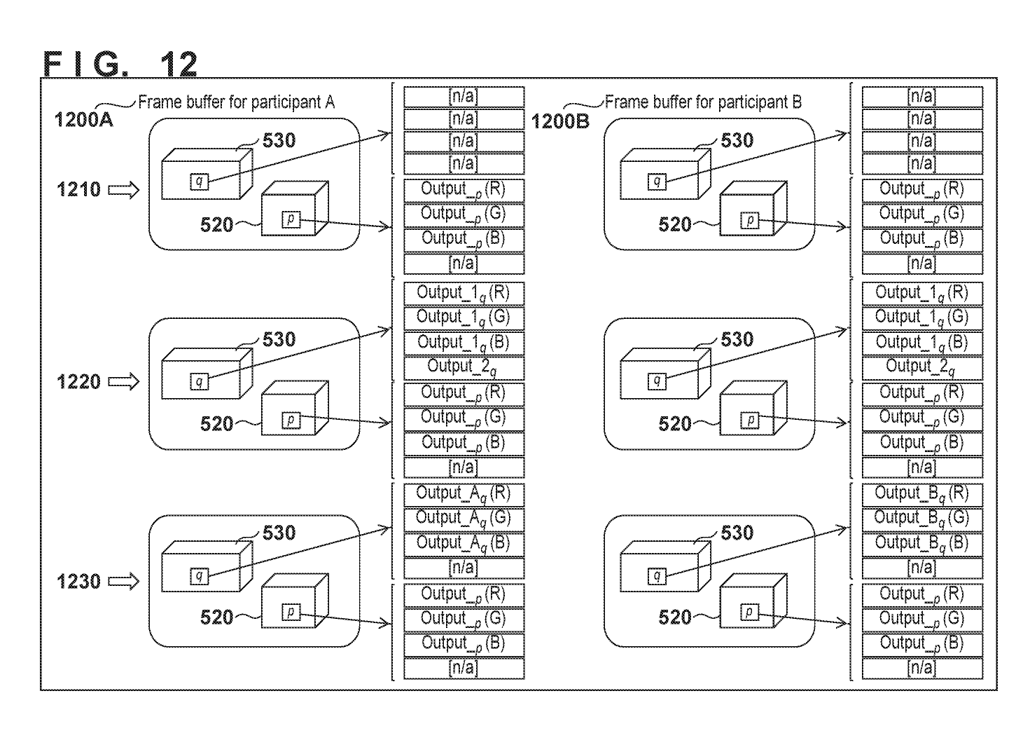

Finally, at step 840, pixel p's pixel value, denoted Outputₚ, is stored in each participant's frame buffer. Specifically, a given pixel associated with the generic object 520 has the same pixel value across the frame buffers for participants A, B and C, and thus once all pixels associated with generic object 520 have been rendered, the generic object 520 appears graphically identical to all participants. Reference is made to FIG. 11, in which it will be seen that the generic object 520 is shaded the same way for participants A, B and C. Thus, the pixel value Ouptutₚ can be computed once and then copied to the each participant's frame buffer. As such, there may be computational savings from rendering the generic object(s) 520 only once such that the pixel value, Outputₚ, is shared among all participants A, B, C. The pixel values may also be referred to as “image data”.

(ii) Pixel Processing for Customizable Object 530

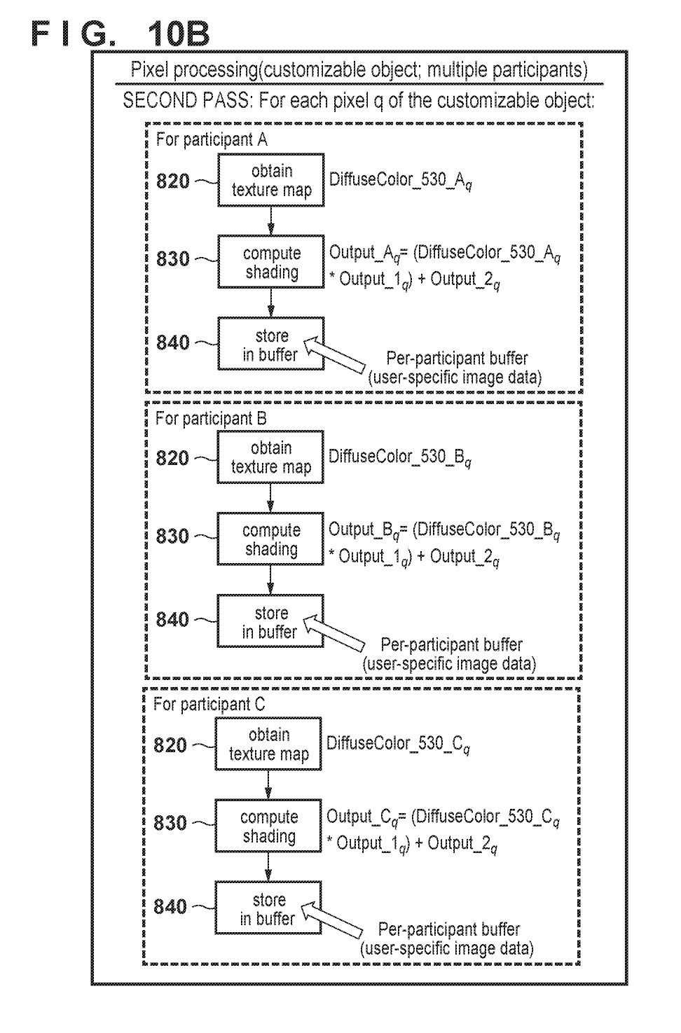

Reference is now made to FIGS. 10A and 10B, which illustrate steps 810-840 in the pixel processing sub-process 780 in the case of a customizable object, such as object 530. These steps may be executed for each pixel q of the customizable object and constitute multiple passes through the pixel processing sub-process. Specifically, FIG. 10A relates to a first pass that may be carried out for all pixels, while FIG. 10B relates to a second pass that may be carried out for all pixels. It is also possible for the second pass to begin for some pixels while the first pass is ongoing for other pixels.

At step 810, the rendering functional module 280 may compute the spectral irradiance at pixel q, which could include a diffuse lighting component DiffuseLighting_{q}, a specular lighting component SpecularLighting_{q} and an ambient lighting component AmbientLighting_{q}. As was the case with FIG. 9, the input to step 810 (in FIG. 10A) may include such items as the content of a depth buffer (also referred to as a “Z-buffer”), a normal buffer, a specular factor buffer, as well as the origin, direction, intensity, color and/or configuration of various light sources that have a bearing on the viewpoint being rendered, and a definition or parameterization of the lighting model used.

In a non-limiting embodiment, “DiffuseLighting_{q}” is the sum (over i) of “DiffuseLighting(q,i)”, where “DiffuseLighting(q,i)” represents the intensity and color of diffuse lighting at pixel q from light source “i”. In a non-limiting embodiment, the value of DiffuseLighting(q,i), for a given light source “i”, can be computed as the dot product of the surface normal and the light source direction (also referenced as “n dot l”). Also, “SpecularLighting_{q}” represents the intensity and color of specular lighting at pixel q. In a non-limiting embodiment, the value of SpecularLighting_{q} may be calculated as the dot product of the reflected lighting vector and the view direction (also referenced as “r dot v”). Finally, “AmbientLighting_{q}” represents the intensity and color of ambient lighting at pixel q. Also it should be appreciated that persons skilled in the art will be familiar with the precise mathematical algorithms used to compute DiffuseLighting_{q}, SpecularLighting_{q} and AmbientLighting_{q} at pixel q.

At step 1010, which still forms part of the first pass, the rendering functional module 280 computes pre-shading values for pixel q. In a non-limiting embodiment, the step 1010 may include subdividing the lighting components into those that will be multiplied by the texture value (diffuse color) of the customizable object 530, and those that will be added to this product. As such, two components of the pre-shading value may be identified for pixel q, namely, “Output_1_{q}” (multiplicative) and “Output_2_{q}” (additive). In a non-limiting embodiment, Output_1_{q}=DiffuseLighting_{q} (i.e., “Output_1_{q}” represents the diffuse lighting value at pixel q); and Output_2_{q}=SpecularLighting_{q}+AmbientLighting_{q} (i.e., “Output_2_{q}” represents the sum of specular and ambient lighting values at pixel q). Of course, it is noted that where there is no ambient lighting component, or when such component is added elsewhere than in the pixel processing sub-process 780, step 1010 does not need to involve any actual computation.

At step 1020, which also forms part of the first pass, the rendering functional module 280 stores the pre-shading values for pixel q in temporary storage. The pre-shading values may be shared amongst all participants that are viewing the same object under the same lighting conditions.

Reference is now made to FIG. 10B, which illustrates the second pass executed for each participant. The second pass executed for a given participant includes steps 820-840 executed for each pixel q.

The example of participant A will be considered first. Accordingly, at step 820, the rendering functional module 280 may consult the texture of the customizable object (in this case, object 530) for participant A to obtain the appropriate diffuse color value at pixel q. The texture can be first identified by consulting the object database 1120 on the basis of the object ID and the participant ID to obtain the texture ID, and then the texture database 1190 can be consulted based on the obtained texture ID to obtain the diffuse color value at pixel q. The resulting diffuse color value is denoted DiffuseColor_530_A_{q}. Specifically, DiffuseColor_530_A_{q} may represent the sampled (or interpolated) value of the texture of object 530 at a point corresponding to pixel q (for participant A).

At step 830, the rendering functional module 280 may compute the pixel value for pixel q. It should be noted that the term “pixel value” could refer to a scalar or to a multi-component vector. In a non-limiting embodiment, the components of such a multi-component vector may be the color (or hue, chroma), the saturation (intensity of the color itself) and the luminance. The word “intensity” may sometimes be used to represent the luminance component. In another non-limiting embodiment, the multiple components of a multi-component vector may be RGB (red, green and blue). In one non-limiting embodiment, the pixel value, which for pixel q is denoted Output_A_{q}, can be computed by multiplicatively combining the diffuse color with the diffuse lighting component (which is retrieved from temporary storage as Output_1_{q}), and then adding thereto the sum of the specular lighting component and the ambient lighting component (which is retrieved from temporary storage as Output_2_{q}). That is to say, Output_A_{q}=(DiffuseColor_530_A_{q}*Output_1_{q})+Output_2_{q}. It should be appreciated that Output_A_{q} may be computed separately for each of multiple components of pixel q (e.g., RGB, YCbCr, etc.).

Finally, at step 840, pixel q's pixel value, denoted Output_A_{q} for participant A, is stored in participant A's frame buffer.

Similarly, for participants B and C, at step 820, the rendering functional module 280 may access the texture of the customizable object (in this case, object 530) for the respective participant to obtain the appropriate diffuse color value at pixel q. The texture can be first identified by consulting the object database 1120 on the basis of the object ID and the participant ID to obtain the texture ID, and then the texture database 1190 can be consulted based on the obtained texture ID to obtain the diffuse color value at pixel q. The resulting diffuse color values at pixel q for participants B and C are denoted DiffuseColor_530_B_{q} and DiffuseColor_530_C_{q}, respectively.

At step 830, the rendering functional module 280 may compute the pixel value for pixel q. In one non-limiting embodiment, the pixel value, denoted Output_B_{q} for participant B and Output_C_{q} for participant C, can be computed by multiplicatively combining the diffuse color with the diffuse lighting component (which is retrieved from temporary storage as Output_1_{q}), and then adding thereto the sum of the specular lighting component and the ambient lighting component (which is retrieved from temporary storage as Output_2_{q}). That is to say, Output_B_{q}=(DiffuseColor_530_B_{q}*Output_1_{q})+Output_2_{q} and Output_C_{q}=(DiffuseColor_530_C_{q}*Output_1_{q})+Output_2_{q}. It should be appreciated that each of Output_B_{q} and Output_C_{q} may be computed separately for each of multiple components of pixel q (e.g., RGB, YCbCr, etc.).

Finally, at step 840, pixel q's pixel value Output_B_{q}, as computed for participant B, is stored in participant B's frame buffer and similarly for participant C and pixel value Output_C_{q}.

Reference is made to FIG. 11, in which it will be seen that the customizable object 530 is shaded differently for participants A, B and C, due to pixel values Output_A_{q}, Output_B_{q} and Output_C_{q} being different.

Thus, it will be appreciated that in accordance with embodiments of the present invention, determining the computationally-intensive irradiance calculations of the pixels of the customizable object(s) can be done once for all participants, yet the pixel value ends up being different for each participant.

This can lead to computational savings when generating multiple “permutations” of the customizable object(s) 530, since the irradiance/light calculations (e.g., DiffuseLighting_{q}, SpecularLighting_{q} AmbientLighting_{q}) for the customizable object(s) 530 are done once (in a first pass) per group of participants rather than per participant. For example, for each given pixel q of the customizable object 530, the values of Output_1_{q} and Output_2_{q} are computed once, and then the pixel value, Output_{q}, is computed separately (in a second pass) for each participant A, B, C based on the common values of Output_1_{q} and Output_2_{q}.

Variant 1

As a variant, temporary storage into which the pre-shading values are stored at step 1020 could be the frame buffer that stores the final image data for one of the participants after execution of step 840 for that participant. Thus, step 1020 can be implemented by using the data element of the frame buffer corresponding to pixel q for a purpose other than to store a true pixel value. For example, the data element corresponding to a pixel q may include components that would ordinarily be reserved for color information (R, G, B, for example) and another component that would ordinarily be reserved for transparency information (alpha).

Specifically, and by way of non-limiting example, the specular lighting and ambient lighting components may be reduced to a single value (scalar), such as its luminance (referred to as “Y” in the YCbCr space). In this case, Output_1_{q} may have three components but Output_2_{q} may have only one. As a result, it may be possible to store both Output_1_{q} and Output_2_{q} for pixel q in a single 4-field data structure for pixel q. Thus, for example, in the case where each pixel is assigned a 4-field RGBA array (where “A” stands for the alpha, or transparency, component), the “A” field can be co-opted for storing a Output_2_{q} value. Furthermore, this may allow a single buffer with 4-dimensional entries to store both the 3-dimensional value of Outputₚ for those pixels “p” pertaining to the generic objects, while simultaneously storing the 3-dimensional value of Output_1_{q} and the one-dimensional value of Output_2_{q} for those pixels q pertaining to customizable objects.

To illustrate this, non-limiting reference is made to FIG. 12A, which shows two frame buffers 1200A, 1200B one for each of participants A and B, respectively. Each of the frame buffers includes pixels with a four-component pixel value. FIG. 12A shows the evolution of the contents of pixels p and q in 1200A, 1200B over time, at the following stages:
1210: after step 840 further to rendering of generic object 520. Note that the pixels for object 520 contain final pixel values (intensities/colors) for object 520. They are computed once and copied to both frame buffers.
1220: after step 1020 further to the first processing pass for customizable object 530. Note that the pixels for object 530 contain pre-shading values for object 530. They are computed once and copied to both frame buffers.
1230: after step 840 further to the second processing pass for customizable object 530. Note that the pixels for object 530 contain final pixel values (intensities/colors) for object 530, which are different for each participant.

Thus, it will be appreciated that a significant portion of the processing can be shared, and once irradiance (lighting) has been computed, customization can occur, leading to potentially significant improvements in computational efficiency when compared with customization that does not take into account the sharing of irradiance computations.

Variant 2

It should further be understood that it is not a requirement that a customizable object be customized for all participants. Also, it is not a requirement that a customizable object within the screen rendering range of a certain number of participants (which may be less than all participants) be customized differently for all those participants. In particular, is possible for certain objects to be customized one way for a first subset of participants and another way for another subset of participants, or for multiple different objects to be customized the same way for a certain participant. For example, consider three participants A, B, C, one generic object 520 (as before) and two customizable objects E, F. It is conceivable that customizable object E is to be customized a certain way for participants A and B, but a different way for participant C. At the same time, it is possible that customizable object F is to be customized a certain way for participants A and C, but a different way for participant B. In this case, the rendering processing for the customizable object E is collectively performed for the participants A and B, and the rendering processing for the customizable object F is collectively performed for the participants A and C.

Thus, there has been described a way to render more efficient the rendering of customized objects while preserving lighting effects. Thus type of customization, which preserves the same irradiance may be useful in the context of providing different participants with different textures based on preferences, demographics, location, etc. For example, participants may be able to see the same objects, with the same realistic effects, but in a different color, or having a different logo, flag, design, language, etc. In some cases, customization could even be used to “grey out” or “darken” objects that need to be censored, e.g., due to age or geographic criteria. Yet even with such a personalized level of customization, the realism that is sought after by participants, and which arises from accurate and complex lighting computations, is not compromised.

Variant 3

In the above-described aspect, a method in which the rendering functional module 280 separately renders generic objects and customizable objects has been explained. On the other hand, when customizing objects by including effects such as lighting, a common effect is applied to generic objects, and an effect desired by each spectator is applied to each customizable object. In this case, a screen formed by pixels generated by these processes may be unnatural, in which only some objects have undergone different effects. In an extreme case, when generic objects occupy most of the screen, if only one customizable object is rendered by including a lighting effect by a light source from a different direction, the customizable object gives a different impression to a spectator in the screen.

In this variant, therefore, a method of reducing unnaturalness in a generated screen by reflecting an effect such as lighting applied to a customizable object on generic objects will be described.

More specifically, to reduce the calculation amount of a screen to be provided to a plurality of spectators, generic objects are rendered in the same manner as in the above-described embodiment. After that, when executing processing of rendering a customizable object in consideration of lighting defined for the customizable objects, calculation related to an effect caused by the customized lighting for the already rendered generic objects is performed. With respect to the calculation related to the effect for the generic objects, when rendering processing performed by using a deferred rendering method or the like, it is possible to readily calculate the luminance change of each pixel by lighting defined by customization since various G-buffers associated with a rendering range have been generated. Therefore, when rendering a customizable object, it is only necessary to, for example, add pixel values obtained by luminance changes and the like to corresponding pixels already rendered.

This increases the calculation amount to some extent. It is, however, possible to reduce unnaturalness in the entire screen caused by other effects applied to customizable objects.

Note, although the order of the rendering processing for the generic objects and the customizable objects is not mentioned in the above described embodiment or variants, the order can be changed depending on the aspects of the rendering functional module 280. For example, in a case where the rendering processing for the generic objects is collectively performed for the participants and the rendering result for the generic objects is stored in a single frame buffer, after the termination of the processing, the frame buffer for each participant may be generated by copying the single frame buffer. In this case, then the rendering processing for the customizable objects according to each participant is separately performed, and the rendering result for the generic objects is stored to the frame buffer corresponding to the participant. In contrast, for example, in a case where the rendering result for the generic objects is stored in each of the plurality of frame buffer (for the participants), the rendering processing for the customizable objects may be performed without waiting the termination of that for the generic objects. That is, both of the rendering processing are performed in parallel and the game screen for each participant is generated in the frame buffer corresponding to the participant.

### Other Embodiments

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions. Also, the rendering apparatus and the rendering method thereof according to the present invention are realizable by a program executing the methods on a computer. The program is providable/distributable by being stored on a computer-readable storage medium or through an electronic communication line.

1-14. (canceled)

15. A rendering apparatus for rendering a plurality of screens, where at least a portion of rendering objects included in the plurality of screens are common to the plurality of screens, comprising:
an identifier which is able to identify, from the common rendering objects, a first rendering object of which rendering attributes are static and a second rendering object of which rendering attributes are variable;
a first renderer which is able to collectively perform rendering processing for the first rendering object for the plurality of screens; and
a second renderer which is able to separately perform rendering processing for the second rendering object for each of the plurality of screens.

16. The rendering apparatus according to claim 15, wherein the second renderer performs the rendering processing after the rendering processing performed by the first renderer.

17. The rendering apparatus according to claim 16, wherein the second renderer copies a rendering result of the first renderer and reflects a rendering result for each of the plurality of screens into the copied rendering result.

18. The rendering apparatus according to claim 15, wherein the rendering processing of the first renderer and the rendering processing of the second renderer are performed in parallel.

19. The rendering apparatus according to claim 15, wherein
the first renderer outputs, for each of the plurality of screens, as a rendering result, the same computation result, and
the second renderer reflects, for each of the plurality of screens, a computation result, which is different for each of the plurality of screens, into the rendering result for the respective screen.

20. The rendering apparatus according to claim 15, wherein the second renderer collectively performs the rendering processing for rendering objects, to which the rendering attributes are common, and which are among the second rendering objects.

21. The rendering apparatus according to claim 15, wherein the second renderer includes rendering processing in which a rendering result of the first renderer is at least partly changed.

22. The rendering apparatus according to claim 15, wherein each of the plurality of screens is a screen displayed by a displaying apparatus which is connected to a different external apparatus,
the rendering apparatus further comprising an obtainer which is able to obtain information for the rendering attributes of the second rendering object for each of the external apparatuses,
wherein the second renderer performs the rendering processing for each of the plurality of screens based on the information for the rendering attributes of the second rendering object.

23. The rendering apparatus according to claim 15, wherein the variable rendering attributes of the second rendering object are attributes by which a pixel value, corresponding to the second rendering object and of the rendering result of the second renderer, can be changed.

24. The rendering apparatus according to claim 15, wherein the variable rendering attributes of the second rendering object include at least one of a texture which is to be applied and an illumination of which there is a possibility that an effect will be considered.

25. The rendering apparatus according to claim 15, wherein the plurality of screens are screens rendered based on the same viewpoint.

26. A rendering method for rendering a plurality of screens, where at least a portion of rendering objects included in the plurality of screens are common to the plurality of screens, comprising:
identifying, from the common rendering objects, a first rendering object of which rendering attributes are static and a second rendering object of which rendering attributes are variable;
collectively performing rendering processing for the first rendering object for the plurality of screens; and
separately performing rendering processing for the second rendering object for each of the plurality of screens.

27. A non-transitory computer-readable storage medium storing a program for causing one or more computers, which include a computer having one or more rendering functions for rendering a plurality of screens, where at least a portion of rendering objects included in the plurality of screens are common to the plurality of screens, to function as the rendering apparatus according to claim 15.
